(19) United States
(12) Patent Application Publication
(10) Pub. No.: US 2015/0210339 A1
(43) Pub. Date: Jul. 30, 2015

(54) STRADDLE-TYPE ELECTRIC VEHICLE

(71) Applicant: Takeshi Igarashi, Shizuoka (JP)

(72) Inventor: Takeshi Igarashi, Shizuoka (JP)

(21) Appl. No.: 14/367,269

(22) PCT Filed: Dec. 19, 2012
(86) PCT No.: PCT/JP2012/082956

§ 371 Date: Jun. 20, 2014

(30) Foreign Application Priority Data
Dec. 22, 2011 (JP) 2011-281201
Dec. 6, 2012 (JP) 2012-267352

(51) Int. Cl. B62K 11/02; B62K 25/04

(52) U.S. Cl. CPC B62K 11/02; B62K 25/04; B62K 2202/00; B62K 2204/00

(57) ABSTRACT

A straddle-type electric vehicle includes a swing arm pivotably supported by a body frame and arranged to support a wheel. A motor is supported on the swing arm to drive the wheel. A battery is supported by the body frame. A cable feeds electric power from the battery to the motor. A portion of the cable extends along a lateral side surface of the battery so as to include a bent portion of the cable.

### BACKGROUND OF THE INVENTION

1. Field of the Invention

The present invention relates to a straddle-type electric vehicle.

2. Description of the Related Art

A motor which drives a wheel of a straddle-type electric vehicle and a battery which supplies electric power to the motor are connected by a power feeding cable. Since the motor is provided on a swing arm which pivots vertically according to road surface conditions, a distance between the battery and the motor changes as the swing arm pivots, there may be a situation in which a tensile load is produced in the power feeding cable.

With a view to mitigating this tensile load, there is known a technique in which a portion where the power feeding cable can be bent is provided in a halfway position along the length of a path where the power feeding cable is laid out, so that the power feeding cable can be deformed to follow the displacement of the swing arm (for example, see International Publication No. WO 2011/033613).

In the case of the straddle-type electric vehicle, since a large number of constituent parts are accommodated in a limited space, it is difficult to provide a space where the power feeding cable is allowed to bend. For example, in the configuration disclosed in International Publication No. WO 2011/033613, a cable extending from a battery is laid out at an upper portion of a vehicle body and laid out at a lower portion of the vehicle body again so as to be connected to a motor on a swing arm. It is desirable that a power feeding cable should be as short as possible from the viewpoint of providing a reliable connection, saving space, and light weight. However, the necessity of providing a bend in the cable prevents a reduction in the length of the cable.

### SUMMARY OF THE INVENTION

Consequently, preferred embodiments of the present invention provide a technique to meet the demand for a shorter power feeding cable while the power feeding cable is also laid out so as to mitigate a tensile load attributed to the movement of a swing arm.

According to a preferred embodiment of the present invention, a straddle-type electric vehicle includes a body frame; a wheel; a swing arm pivotably supported by the body frame and supporting the wheel; a motor supported on the swing arm and configured to drive the wheel; a battery supported by the body frame; and a cable configured to feed electric power from the battery to the motor, wherein a portion of the cable extends along a lateral side surface of the battery and the portion of the cable includes a bent portion.

With this configuration, a tensile load produced in the power feeding cable by pivoting movement of the swing arm is mitigated by corresponding bending or stretching of the bent portion. By making use of the space which is inherently formed on the side of the lateral side surface of the battery as the cable accommodation space to a large extent, it is possible to connect the battery and the electric motor in a very short or minimal distance. Consequently, it is possible to meet the demand for a shorter cable while mitigating the tensile load caused by the pivoting movement of the swing arm by the bent portion.

In a case where the battery has a rectangular or substantially rectangular parallelepiped shape, and where the lateral side surface of the battery extends along a longitudinal direction of the battery, almost the entire length of the power feeding cable is allowed to extend along the lateral side surface, thus making it possible to easily include a bent portion in the cable.

In a case where the lateral side surface of the battery is a flat side surface facing a left-to-right direction, there is no such situation in which the lateral side surface prevents the bending or stretching of the power feeding cable which occurs in association with the pivoting movement of the swing arm. Consequently, the tensile load produced in the power feeding cable by the pivoting swing arm is mitigated.

In a case where the cable extends in a space between the lateral side surface of the battery and the body frame, this dead space which is inherently formed as a result of the battery being disposed in the manner described above is used as a cable accommodation space to a large extent. Additionally, the power feeding cable is allowed to bend or stretch along the lateral side surface of the battery within the relatively narrow space. Consequently, the tensile load produced in the power feeding cable by the pivoting swing arm is mitigated.

In a case where one end of the cable is connected to an upper portion of the battery, an electrical connecting portion where the power feeding cable and the battery are electrically connected is positioned farther away from the ground, and therefore, it is possible to protect the electrical connecting portion from small stones which are thrown up while the vehicle is running.

The above and other elements, features, steps, characteristics and advantages of the present invention will become more apparent from the following detailed description of the preferred embodiment s with reference to the attached drawings.

### BRIEF DESCRIPTION OF THE DRAWINGS

FIG. 1 is a left side view showing a two-wheeled electric vehicle according to a preferred embodiment of the present invention.

FIG. 2 is a left side view of the two-wheeled electric vehicle shown in FIG. 1 with some of constituent components removed therefrom.

FIG. 3 is a right side view showing a rear portion of the two-wheeled electric vehicle shown in FIG. 1.

FIG. 4 is a plan view showing the inside of side covers of the two-wheeled electric vehicle shown in FIG. 1.

FIG. 5 is a right side view showing a relationship between a pivot movement of a swing arm and bending or stretching of a power feeding cable on the two-wheeled electric vehicle shown in FIG. 1.

FIG. 6 is a right side view showing a relationship between a pivot movement of a swing arm and bending or stretching of a power feeding cable on the two-wheeled electric vehicle wherein a battery arrangement is modified.

### DETAILED DESCRIPTION OF THE PREFERRED EMBODIMENTS

Referring to the accompanying drawings, preferred embodiments of the present invention will be described in detail below. In the individual drawings used in the following description, the scales are changed as required so that individual constituent members are illustrated in appropriate sizes so as to be easily illustrated and understood.

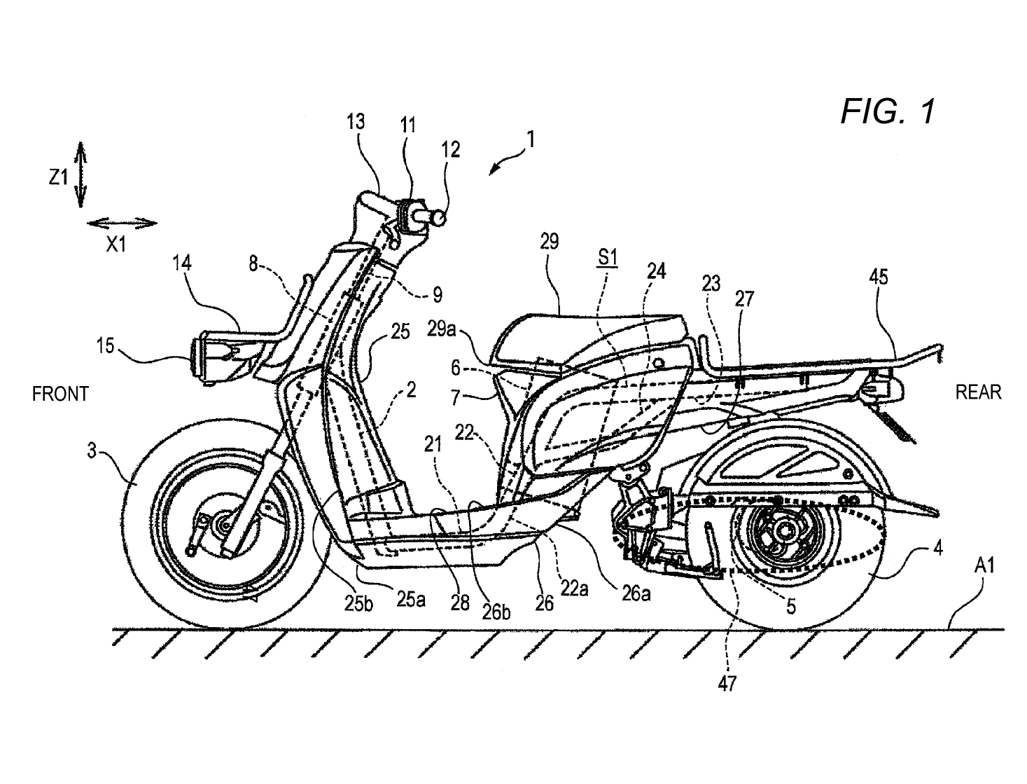

FIG. 1 is a left side view showing a two-wheeled electric vehicle according to a preferred embodiment of the present invention. In the present preferred embodiment, a two-wheeled electric vehicle 1 in the form of a scooter will be described as an example of a straddle-type electric vehicle. The two-wheeled electric vehicle 1 is configured to have luggage placed at a front portion and a rear portion thereof and is suitable as a luggage carrying vehicle.

Directions denoted as front and rear, top and bottom, as well as left and right are based on a standard posture of the two-wheeled electric vehicle 1 which corresponds to a state in which the two-wheeled electric vehicle 1 runs straight ahead on a horizontal plane and the point of view of a rider when the rider faces the front of the vehicle. In addition, the configuration of the two-wheeled electric vehicle 1 will be described based on the two-wheeled electric vehicle 1 in such a state that the vehicle stands erect, a front wheel 3 and a rear wheel 4 are in contact with a road surface A1, and the vehicle is in an unloaded state without a rider.

The two-wheeled electric vehicle 1 includes a body frame 2, the front wheel 3, the rear wheel 4, an electric motor 5, a battery 6, and a body cover 7. In the two-wheeled electric vehicle 1, the electric motor 5 is driven by electric power supplied from the battery 6, and the rear wheel 4 is driven by the output of the electric motor 5. The electric motor 5 is accommodated in a swing arm 47 which is disposed rightward of the rear wheel 4. Hereinafter, an overall construction of the two-wheeled electric vehicle 1 will be described sequentially from the front of a vehicle body.

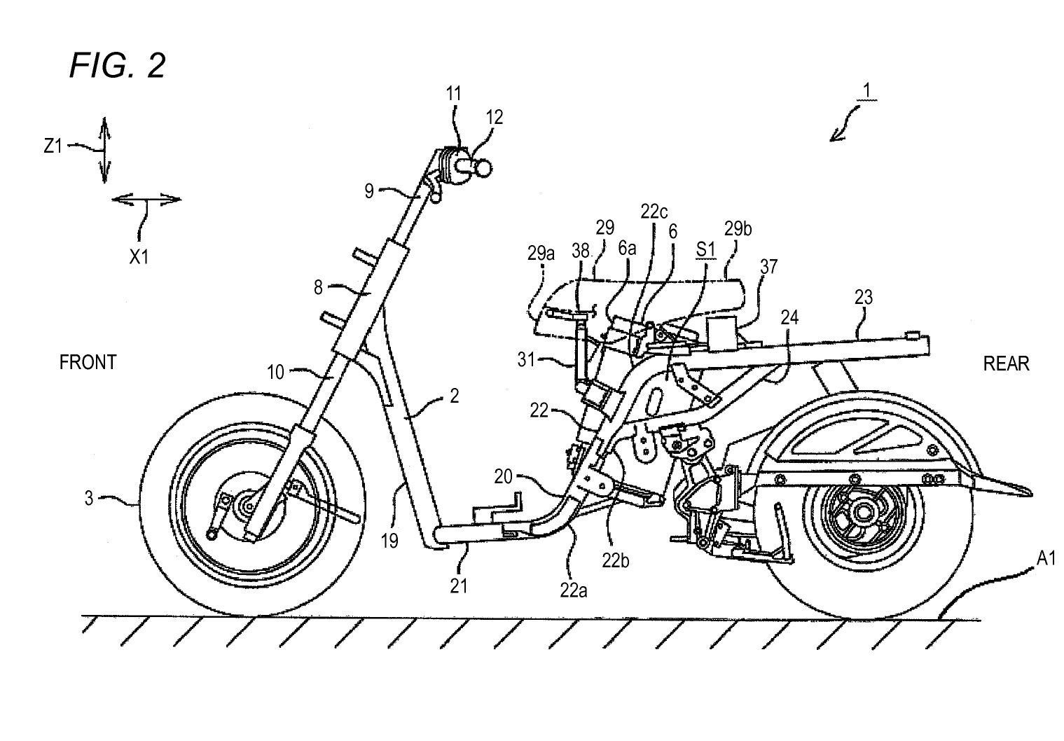

FIG. 2 is a left side view of the two-wheeled electric vehicle shown in FIG. 1 with some of constituent components removed therefrom. The two-wheeled electric vehicle 1 includes a head pipe 8 disposed at a front upper portion of the two-wheeled electric vehicle 1. A steering shaft 9 is inserted rotatably in the head pipe 8. A front fork 10 including a pair of left and right fork legs is mounted at a lower end portion of the steering shaft 9. The front wheel 3 is attached to the front fork 10.

A handlebar 11 is mounted at an upper end portion of the steering shaft 9. The rider controls the handlebar 11 so as to turn the steering shaft 9, the front fork 10, and the front wheel 3 around an axis of the steering shaft 9.

Grips 12 are provided individually at both left and right end portions of the handlebar 11 (only a left grip is shown). A right grip includes a throttle grip. The rider turns the throttle grip so as to control the output of the electric motor 5.

As shown in FIG. 1, a meter 13 is provided in the vicinity of a center of the handlebar 11. A luggage rack 14 is disposed below the meter 13. The luggage rack 14 is fixed to the head pipe 8. The load of luggage placed on the luggage rack 14 acts mainly on the front wheel 3 via the head pipe 8 and the steering shaft 9. A headlamp 15 is fixed to a lower portion of the luggage rack 14.

As shown in FIG. 2, the two-wheeled electric vehicle 1 includes a body frame 2 which extends rearwards from the head pipe 8. The body frame 2 is made of steel pipe members or the like. The body frame 2 includes a down tube 19 and a frame main body 20 which is disposed rearward of the down tube 19. The down tube 19 extends obliquely downwards and rearwards from a lower portion of the head pipe 8. When seen from the side, the frame main body 20 extends rearwards from a lower end portion of the down tube 19, and a halfway portion of the frame main body 20 in relation to a front-to-rear direction X1 of the vehicle has an S shape.

The frame main body 20 includes a pair of left and right frame main bodies. The frame main body 20 includes a first frame portion 21, a second frame portion 22, a third frame portion 23, and a fourth frame portion 24. The first frame portion 21 extends straight or substantially straight and rearwards from the lower end portion of the down tube 19 and is slightly inclined obliquely upwards and rearwards.

The second frame portion 22 has an S shape when seen from the side. The second frame portion 22 includes a lower end portion 22a, a middle portion 22b, and an upper end portion 22c. The lower end portion 22a of the second frame portion 22 has a curved shape and is connected to a rear end portion of the first frame portion 21. The middle portion 22b of the second frame portion 22 extends obliquely upwards and rearwards from the lower end portion 22a. When seen from the side, an inclination angle of the middle portion 22b in relation to the first frame portion 21 is, for example, about 45 degrees, for example. The upper end portion 22c of the second frame portion 22 has a curved shape and is connected to the middle portion 22b.

The third frame portion 23 extends rectilinearly from the upper end portion 22c and is slightly inclined obliquely upwards and rearwards. The fourth frame portion 24 extends rearwards from the middle portion 22b of the second frame portion 22, is curved obliquely upwards in a halfway position, and is connected to a middle portion of the third frame portion 23.

As shown in FIG. 1, the two-wheeled electric vehicle 1 includes the body cover 7 which is attached to the body frame 2. The body cover 7 includes a front cover 25 which covers the head pipe 8, a lower cover 26 which extends downwards from a lower portion of the front cover 25, and a rear cover 27 which is disposed rearward of the front cover 25.

The front cover 25 surrounds a portion of the steering shaft 9 and the head pipe 8 and also surrounds the down tube 19. The lower cover 26 extends rearwards from a lower portion 25a of the front cover 25 and covers the first frame portions 21 and the lower end portions 22a of the second frame portions 22 from below, the left, and the right thereof. A foot rest portion 28 is disposed at an upper end portion of the lower cover 26. The foot rest portion 28 is provided so that the rider rests his or her feet thereon and is flat or substantially flat.

The rear cover 27 is configured, as a whole, so as to extend obliquely upwards and rearwards from a rear portion 26a of the lower cover 26. The rear cover 27 covers areas of the second frame portions 22 excluding the lower end portions 22a from the front, the left, and the right thereof. Additionally, the rear cover 27 covers the third frame portions 23 and the fourth frame portions 24 from the front, the left, and the right thereof.

A seat 29 is disposed above the rear cover 27. The feet of the rider sitting on the seat 29 rest on the foot rest portion 28 while the two-wheeled electric vehicle 1 is running. In the front-to-rear direction X1, the foot rest portion 28 is disposed between a rear surface 25b of the front cover 25 and a front end portion 29a of the seat 29. Additionally, the seat 29 is disposed above the second frame portions 22, a portion of the third frame portions 23, and a portion of the fourth frame portions 24. A space surrounded by the seat 29 and the rear cover 27 defines an accommodation space S1.

As shown in FIG. 2, the seat 29 is supported by a first bracket 31 and a support bracket 37 and defines a portion of an external surface of the vehicle body. The first bracket 31 is mounted at the middle portions 22b of the second frame portions 22. The first bracket 31 extends upwards from the middle portions 22b. A hinge portion 38 is provided at an upper end portion of the first bracket 31. The seat 29 is supported by the first bracket 31 via the hinge portion 38. The first bracket 31 supports the seat 29 from below. The seat 29 pivots about the hinge portion 38. The accommodation space S1 can be opened upwards by pivoting the seat 29 about the hinge portion 38. It is noted that the hinge portion 38 may be omitted so that the seat 29 is fixed directly to the first bracket 31.

A rear portion 29b of the seat 29 is supported by the support bracket 37. The support bracket 37 is fixed to the third frame portions 23 of the body frame 2 and is configured so as to project upwards from the third frame portions 23.

The battery 6, which is a power supply for the electric motor 5, is disposed below the seat 29. The battery 6 is disposed between the pair of left and right second frame portions 22. The battery 6 is a rechargeable secondary battery. When seen from the side, the battery 6 has a rectangular or substantially rectangular shape in which a height in a vertical direction Z1 of the vehicle is longer than a length in the front-to-rear direction X1. The battery 6 is inclined obliquely rearwards with its front end located higher than its rear end and is supported on the body frame 2. An upper portion 6a of the battery 6 is disposed between the first bracket 31 and the support bracket 37.

As shown in FIG. 1, a luggage rack 45 is disposed at the rear of the seat 29. The luggage rack 45 is disposed on the third frame portions 23 to be supported by the third frame portions 23. Luggage can be placed on the luggage rack 45. The load of the luggage placed on the luggage rack 45 is supported mainly by the rear wheel 4.

In this manner, the luggage rack 14, the battery 6 which is heavy, and the luggage rack 45 are disposed so as to be aligned in the front-to-rear direction X1. Consequently, when luggage is placed on the luggage rack 14 and the luggage rack 45, the load of the two-wheeled electric vehicle 1 is balanced evenly in the front-to-rear direction X1. Consequently, even with the luggage placed on the luggage rack 14 and the luggage rack 45, it is possible to maintain high controllability of the two-wheeled electric vehicle 1.

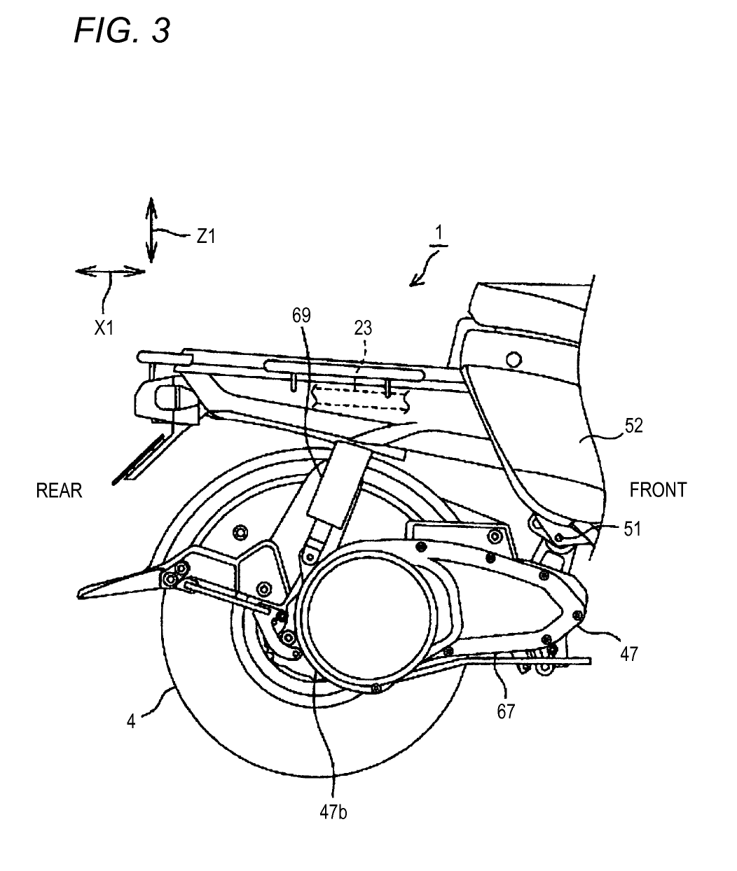

FIG. 3 is a right side view showing a rear portion of the two-wheeled electric vehicle 1. The two-wheeled electric vehicle 1 includes the swing arm 47 supported so as to pivot about a pivot shaft 51 relative to the body frame 2. The swing arm 47 supports the rear wheel 4 the present invention. The electric motor 5, which drives the rear wheel 4, is installed in the swing arm 47 together with a motor controller or the like. Side covers 52 are provided above the pivot shaft 51.

The swing arm 47 is disposed rightward of the rear wheel 4. A rear portion 47b of the swing arm 47 is connected to the third frame portion 23 via a shock absorber 69. With this configuration, a shock produced when the swing arm 47 pivots is attenuated and absorbed by the shock absorber 69.

When seen from the side, the swing arm 47 is disposed below the third frame portion 23. A motor case 67 of the swing arm 47 is configured so that a length in the front-to-rear direction X1 is longer than a length in the vertical direction when seen from the side.

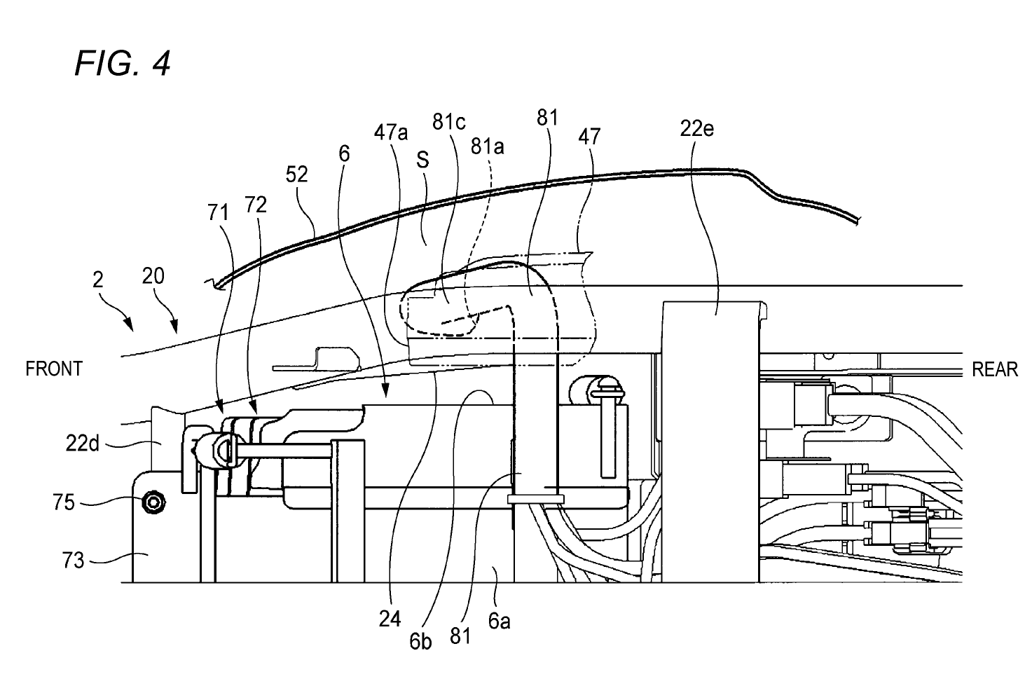

FIG. 4 is a plan view showing a configuration inside the side covers 52. The battery 6 is disposed between the second frame portions 22 by a support member 72 including a pedestal 71, and is supported on the body frame 2. Specifically, the battery 6 is inserted between the second frame portions 22 from above such that fixing piece portions 73 (only a front one is shown) provided at the front and rear of the pedestal 71 of the battery 6 rest on brackets 22d, 22e which bridge the second frame portions 22. In this state, the fixing piece portions 73 and the brackets 22d, 22e are fastened together with bolts 75, for example, such that the pedestal 71 is fixed to the individual brackets 22d, 22e.

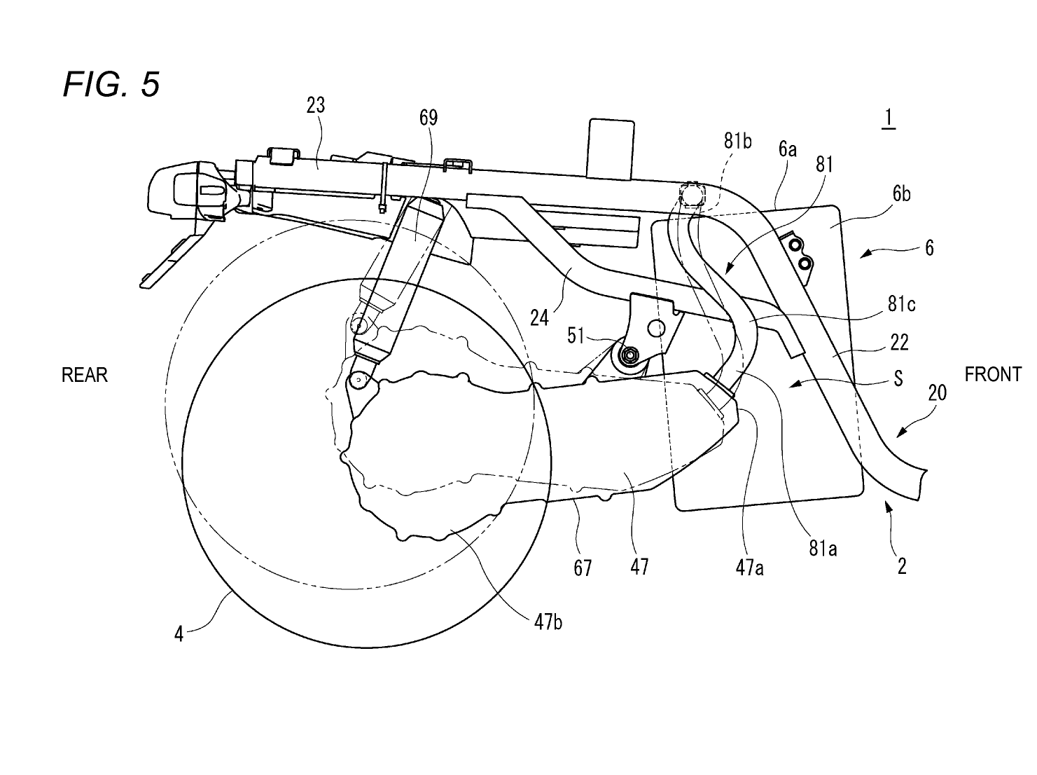

As shown in FIGS. 4 and 5, the swing arm 47, which includes the electric motor 5, and the battery 6 are connected by a power feeding cable 81. The power feeding cable 81 is connected to a front portion 47a of the swing arm 47 at a lower end 81a thereof and is connected to an upper portion 6a of the battery 6 at a lower end 81b thereof. The power feeding cable 81 supplies electric power from the battery 6 to the electric motor 5.

The battery 6 has a rectangular or substantially rectangular parallelepiped shape. A lateral side surface 6b extends along a longitudinal direction of the battery 6. The lateral side surface 6b of the battery 6 is a flat or substantially flat surface which faces a left-to-right direction of the vehicle.

When the battery 6 configured in the manner described above is mounted on the body frame 2, a space along the lateral side surface 6b of the battery 6 is defined between the lateral side surface 6b of the battery 6 and the body frame 2, and this space defines a cable accommodation space S where the power feeding cable 81 extends.

The power feeding cable 81 extends along the lateral side surface 6b of the battery 6 which is supported on the body frame 2 as a result of a portion of the power feeding cable 81 being accommodated in the cable accommodation space S. Additionally, by loosening the power feeding cable 81 within the cable accommodation space S which contains the cable portion, a bent portion 81c is formed in the power feeding cable 81. A tensile load produced in the power feeding cable 81 by the pivoting movement of the swing arm 47 is mitigated by bending and stretching of the bent portion 81c as indicated by a solid line and a dashed chain line in FIG. 5. Here, the solid line denotes a state in which the rear wheel 4 is positioned at its lowest (a state in which the shock absorber 69 extends), while the dashed chain line denotes a state in which the rear wheel 4 is positioned at its highest (a state in which the shock absorber 69 contracts).

It is desired that the power feeding cable 81 should be as short as possible from the viewpoint of providing a reliable connection, saving space, and light weight. However, in the straddle-type electric vehicle such as the two-wheeled electric vehicle 1, since a large number of constituent parts are accommodated in a limited space, a space to accommodate the power feeding cable 81 where the bent portion 81c is arranged to absorb the pivoting movement of the swing arm 47 is limited. Consequently, it is generally required that the power feeding cable 81 with the bent portion 81c formed therein extends in various directions in the limited space making it difficult to shorten the length of the power feeding cable 81.

According to the configuration of the present preferred embodiment, a portion of the power feeding cable 81 extends in such a way as to provide the bent portion 81c along the lateral side surface 6b of the battery 6. By making use of the space inherently formed on the side of the lateral side surface 6b of the battery 6 as the cable accommodation space S to a large extent, it is possible to connect the battery 6 and the electric motor 5 by a very short or minimal distance. Consequently, it is possible to meet the demand for a shorter cable while mitigating the tensile load caused by the pivoting movement of the swing arm 47 by the bent portion 81c.

In the present preferred embodiment, the space formed at the side of the lateral side surface 6b of the battery 6 which extends along the longitudinal direction of the battery 6 defines the cable accommodation space S. Because of this, almost the entire length of the power feeding cable 81 is allowed to extend along the lateral side surface 6b, thus making it possible to easily provide a bent portion 81c in the power feeding cable 81.

Additionally, since the lateral side surface 6b is the flat side surface which faces the left-to-right direction of the vehicle, there is no such situation that the lateral side surface 6b prevents the bending or stretching of the power feeding cable 81 which occurs in association with the pivoting movement of the swing arm 47. Consequently, the tensile load produced in the power feeding cable 81 by the pivoting swing arm 47 is mitigated.

Further, the power feeding cable 81 extends within the space formed between the lateral side surface 6b and the body frame 2. This dead space, which is inherently formed as a result of the battery 6 being disposed in the manner described above, makes use of the cable accommodation space S to a large extent. Additionally, the power feeding cable 81 is allowed to bend or stretch along the lateral side surface 6b of the battery 6 by the relatively narrow space. Consequently, the tensile load produced in the power feeding cable 81 by the pivoting swing arm 47 is mitigated.

In the present preferred embodiment, an upper end 81a of the power feeding cable 81 is connected to an upper portion 6a of the battery 6. Namely, an electrical connecting portion where the power feeding cable 81 and the battery 6 are electrically connected is positioned farther away from the ground, and therefore, it is possible to protect the electrical connecting portion from small stones which are thrown up while the vehicle is running.

The preferred embodiments that have been described heretofore are intended to facilitate the understanding of the present invention and are not intended to limit the present invention. The preferred embodiments of the present invention can be modified or combined variously without departing from the spirit and scope thereof and equivalents thereof are included in the present invention.

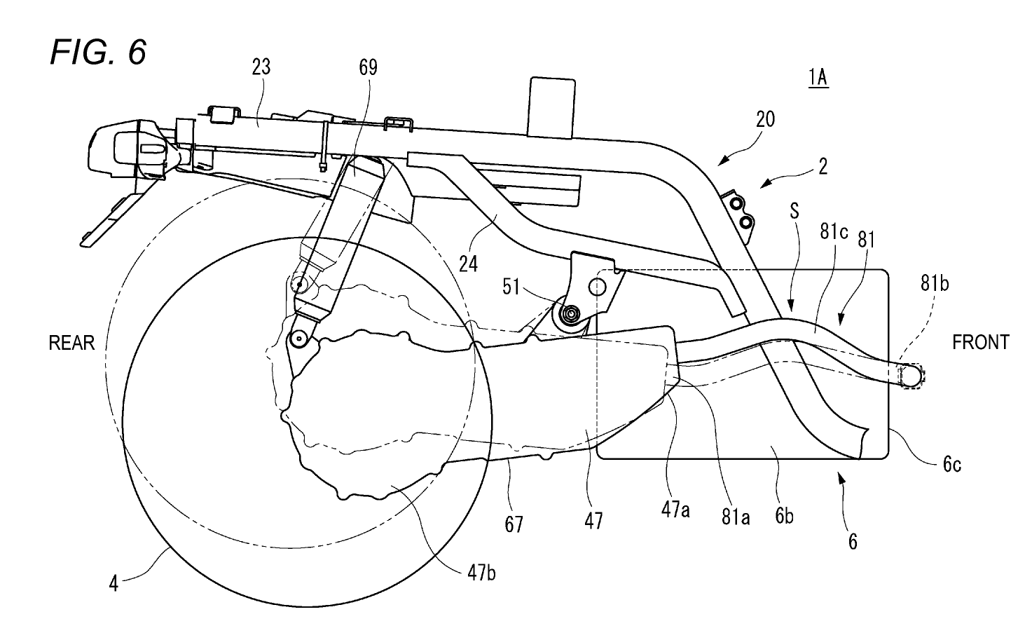

The disposition of the battery 6 is not limited to the configuration of the preferred embodiments described above. For example, as shown in FIG. 6, a battery 6 may be disposed so that the longitudinal direction of the rectangular or substantially rectangular parallelepiped battery 6 is oriented in the front-to-rear direction of the vehicle. As this occurs, a power feeding cable 81 extending from a swing arm 47 is connected to a front portion 6c of the battery 6 which is disposed at a position closer to the front end of the vehicle.

Also, in the case of a two-wheeled electric vehicle 1A in which the battery 6 is disposed in the manner described above, a space along a lateral side surface 6b of the battery 6 is formed between the lateral side surface 6b of the battery 6 and the body frame 2, and this space constitutes a cable accommodation space S where the power feeding cable 81 can be laid out.

The power feeding cable 81 is laid out so as to extend along the lateral side surface 6b of the battery 6 which is supported on the body frame 2 as a result of a portion of the power feeding cable 81 being accommodated in the cable accommodation space S. Additionally, by loosening the power feeding cable 81 within the cable accommodation space S which contains the cable portion, a bent portion 81c is formed in the power feeding cable 81. A tensile load produced in the power feeding cable 81 as the swing arm 47 pivots is mitigated by the bent portion 81c bending or stretching as indicated by a solid line and a dashed chain line in FIG. 6. Here, the solid line denotes a state in which the rear wheel 4 is positioned at its lowest (a state in which the shock absorber 69 extends), while the dashed chain line denotes a state in which the rear wheel 4 is positioned at its highest (a state in which the shock absorber 69 contracts).

The number of wheels of the straddle-type electric vehicle to which the preferred embodiments of the present invention is applied is not limited to two and hence can be determined as required.

Japanese Patent Application No. 2011-281201 filed Dec. 22, 2011 and Japanese Patent Application No. 2012-267352 filed Dec. 6, 2012 are incorporated herein by reference in their entirety.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-5. (canceled)

6. A straddle-type electric vehicle comprising:
a body frame;
a wheel;
a swing arm pivotably supported by the body frame and supporting the wheel;
a motor supported on the swing arm and configured to drive the wheel;
a battery supported by the body frame; and
a cable configured to feed electric power from the battery to the motor; wherein
a portion of the cable extends along a lateral side surface of the battery and the portion of the cable includes a bent portion.

7. The straddle-type electric vehicle as set forth in claim 6, wherein the battery has a rectangular or substantially rectangular parallelepiped shape, and the lateral side surface of the battery extends along a longitudinal direction of the battery.

8. The straddle-type electric vehicle as set forth in claim 6, wherein the lateral side surface of the battery is a flat side surface oriented in a left-to-right direction of the vehicle.

9. The straddle-type electric vehicle as set forth in claim 6, wherein the cable extends in a space between the lateral side surface of the battery and the body frame.

10. The straddle-type electric vehicle as set forth in claim 6, wherein one end of the cable is connected to an upper portion of the battery.
